(19) United States
(12) Patent Application Publication
(10) Pub. No.: US 2005/0166941 A1
(43) Pub. Date: Aug. 4, 2005

(54) Disposable toilet bowl wand with detergent-filled sponge

(76) Inventor: Lucrezia Colantonio, Elkins Park, PA (US)

Correspondence Address: LUCREZIA COLANTONIO, 306 ROLLING HILL RD, ELKINS PARK, PA, 19027-1829, US

(21) Appl. No.: 10/770,175

(22) Filed: Feb. 2, 2004

(51) Int. Cl. B08B 9/00

(52) U.S. Cl. 134/6; 134/22.1

(57) ABSTRACT

The Disposable Toilet Bowl Wand with Detergent-filled Sponge is a one step toilet bowl cleaning tool that is meant to be used once and discarded. The purpose is to create a sanitary solution for a messy job. In addition, this invention eliminates the need to store toilet bowl cleaning tools that may contain harmful germs and bacteria.

### BACKGROUND OF THE INVENTION

The present invention pertains to the cleaning of toilet bowls and more precisely to an improved, more efficient and more sanitary approach to accomplish what is presently a messy job.

### SUMMARY OF THE INVENTION

The present invention is unique for several reasons: 1) it is totally disposable, 2) it is intended for one time usage, 3) it is a one piece system that contains a detergent-filled sponge applicator, and 4) it utilizes recyclable and biodegradable materials. The concept is to use and discard; thereby, avoiding contact with germs and bacteria that may occur when storing re-usable toilet bowl cleaning tools.

### BRIEF DESCRIPTION OF THE DRAWINGS

FIG. 1 is a components view that depicts the materials used in the invention.

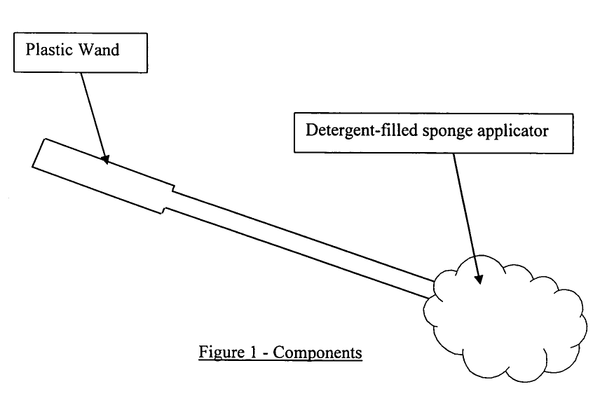

FIG. 2 is a dimensional view that depicts the approximate size of the invention.

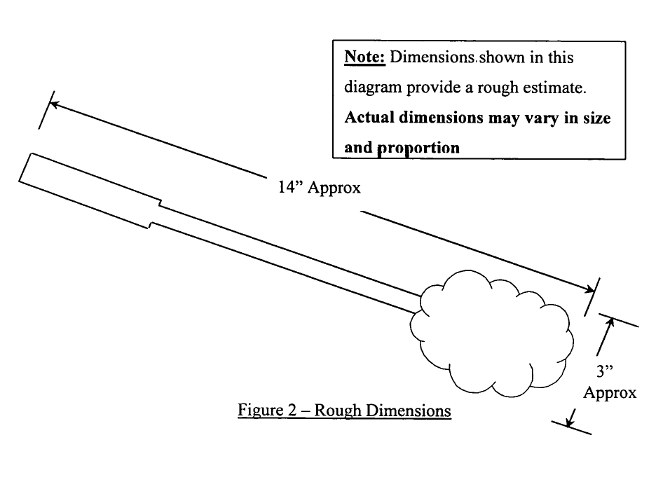

### DETAILED DESCRIPTION

The present invention is unique because it is totally disposable and is comprised of a one piece handle (wand) and detergent-filled sponge. It is intended for one time use and can be manufactured very inexpensively because it is not designed for durability. In addition, it will be manufactured using recyclable plastic and biodegradable materials. The plastic handle and detergent-filled sponge will clean quickly and effectively.

The concept is to “use and discard”; thereby, avoiding prolonged exposure to the germs and bacteria that occurs when storing the toilet bowl cleaning tools such as brushes, brush handles and applicators. For example the following products, presently on the market, require storage of part or all of the components used to clean toilet bowls:

(1) “Scrub and flush” has a chemically treated brush head which is disposable; however, the handle is designed for repeated usage and is stored on the side of the toilet tank. This could only result in germs and bacteria on the part of handle that gets immersed in the toilet bowl.

(2) Lysol “Ready Brush”, again offers a cleaning tool with attached brush. A separate Lysol container filled with detergent is inserted into this tool to push the cleaning agent into the brush. Eventually, the Lysol container is replaced but tool and brush are stored and used again.

(3) Plastic handles with attached brushes or sponges that are designed to be re-usable. In order to use these tools, detergent must be added to the toilet bowl. These tools are designed to be stored for future use.

In each of the examples above, parts of the product are exposed to unsanitary conditions which may result in exposure to harmful germs and bacteria during the storage and handling of the product.

Finally, the specifications for the size and proportions of the current invention may vary; however, the intent of the present invention is original because the tool is designed for one time use and is more convenient and sanitary than products currently on the market. More precisely, the added convenience is gained through the use of a detergent-filled applicator sponge which eliminates the need for a separate detergent. In addition, the product is designed to be discarded after use, which eliminates exposure to germs and bacteria that may occur during storage.

1. A toilet bowl cleaning tool that is comprised of a plastic wand with an attached detergent-filled sponge applicator.

2. A toilet bowl cleaning tool as claimed in claim 1 in which the entire tool is disposable, non-flushable, and designed for one time use.

3. A toilet bowl cleaning tool as claimed in claims 1-2 in which the plastic wand is comprised of recyclable plastic and the detergent-filled sponge applicator is comprised of biodegradable materials.
